(19) United States
(12) Patent Application Publication
(10) Pub. No.: US 2021/0204094 A1
(43) Pub. Date: Jul. 1, 2021

(54) TRACKING WIRELESS PERIPHERAL DEVICES

(71) Applicant: Micron Technology, Inc., Boise, ID (US)

(72) Inventors: Bhumika Chhabra, Boise, ID (US); Claudia A. Delaney, Garden City, ID (US); Madison E. Wale, Boise, ID (US); Elsie de la Garza Villarreal, Nampa, ID (US)

(21) Appl. No.: 16/943,097

(22) Filed: Jul. 30, 2020

Related U.S. Application Data
(60) Provisional application No. 62/955,713, filed on Dec. 31, 2019.

(51) Int. Cl. H04W 4/029; H04W 76/14; H04W 24/10; H04W 4/02; H04W 4/20

(52) U.S. Cl. CPC H04W 4/029; H04W 76/14; H04W 4/20; H04W 4/023; H04W 4/027; H04W 24/10

(57) ABSTRACT

Methods and apparatuses for tracking a wireless peripheral device are described, in which various parameters are monitored to determine whether a predetermined condition satisfies a threshold. The parameters may be associated with a wireless communication link established between the wireless peripheral device and a host device. Further, the predetermined conditions may be related to circumstances that may result in losing the wireless communication link and/or the wireless peripheral device. In some cases, the wireless peripheral device may spontaneously transmit signals to the host device to inform its location or to request the host device to perform certain tasks. In some cases, the host device may send a command to the wireless peripheral device to report its location. Also, the wireless peripheral device may be configured to notify the owner upon accepting an input from a person who finds the wireless peripheral device.

### CROSS-REFERENCE TO RELATED APPLICATION

This application claims the benefit of U.S. Provisional Application No. 62/955,713, filed Dec. 31, 2019; which is incorporated herein by reference in its entirety.

### TECHNICAL FIELD

The present disclosure generally relates to wireless devices, and more particularly relates to tracking wireless peripheral devices coupled with a mobile device.

### BACKGROUND

Wireless peripheral devices are widely used in many home, business, and/or personal applications and come in many different sizes and shapes. Small wireless peripheral devices (e.g., wireless earbuds) may be coupled with a host device (e.g., a cellular phone) for a user to benefit from various infotainment features in a mobile environment. Such small wireless peripheral devices, however, are hard to keep track of, and likely to be lost when the user remove them and forget their whereabouts. Sometimes, a third party may find them but may not have any means to notify or return them to the owner. The wireless peripheral devices tend to be costly to replace and may become targets of theft. It would be beneficial for the owners to be able to track locations of the wireless peripheral devices to reduce likelihoods of losing them. Further, being able to track and/or locate the wireless peripheral device may discourage unauthorized taking of the wireless peripheral devices.

### BRIEF DESCRIPTION OF THE DRAWINGS

FIG. 1 shows block diagrams illustrating schemes of tracking wireless peripheral audio devices in accordance with embodiments of the present technology.

FIG. 2 is a block diagram schematically illustrating a wireless peripheral device in accordance with an embodiment of the present technology.

FIGS. 3 and 4 are flowcharts illustrating methods of tracking wireless peripheral devices in accordance with embodiments of the present technology.

### DETAILED DESCRIPTION

Wireless peripheral devices (e.g., wireless earbuds) provide convenient means for users to enjoy various infotainment features of personal electronic devices (e.g., cellular phones, tablets, or other portable media players capable of playing music, videos, and/or other media content), without the inconvenience of a wired connection. The convenience of the wireless peripheral devices, however, may be mitigated by an increased likelihood of losing them and/or the cost of replacing them when they are lost. Several embodiments of the present technology provide capabilities to track and/or locate a wireless peripheral device, in some cases, based on a wireless communication link that the wireless peripheral device establishes with a host device (e.g., a cellular phone).

For example, the wireless peripheral device may determine that certain conditions are met (e.g., conditions related to an imminent disconnection from the host device or otherwise becoming lost), and spontaneously inform the host device of its location (and/or the conditions). In other examples, the host device may detect similar conditions (e.g., conditions related to potentially losing the wireless peripheral device) and request the wireless peripheral device to report its location. Subsequently, the host device may notify the owner and/or record the location received from the wireless peripheral device to assist the owner to track and/or locate the wireless peripheral device. As such, the wireless peripheral device may include a location tracking component configured to determine its geological location (e.g., determined by a global positioning system (GPS)). Such location reporting capability of the wireless peripheral device may help to reduce theft attempts. Additionally, or alternatively, an embodiment of the present technology provides means for a third party to notify the owner when the wireless peripheral device is found.

In some embodiments, a wireless peripheral audio device (e.g., wireless earbuds) may establish a wireless communication link with a mobile device (e.g., a cellular phone) that generates an audio signal and sends the audio signal to the wireless peripheral audio device via the wireless communication link. The wireless peripheral audio device may monitor a parameter associated with the wireless communication link to determine that a predetermined condition satisfies a threshold (e.g., certain conditions likely to result in loss of the wireless peripheral audio device). Thereafter, the wireless peripheral audio device may transmit a signal to the mobile device, where the signal may include a location of the wireless peripheral audio device, a request for the mobile device to perform certain tasks (e.g., recording the location of the wireless peripheral audio device, notifying a user of the wireless peripheral audio device), various information about the parameter, which may assist the user to track and/or locate the wireless peripheral audio device.

For example, the parameter corresponds to a strength of the audio signal transmitted from the mobile device, which may facilitate the wireless peripheral audio device to determine a distance from the mobile device. When the distance approaches (or is equal to) a maximum distance for the wireless peripheral audio device to maintain the wireless communication link, the wireless peripheral audio device may transmit the signal to the mobile device before the wireless communication link no longer exists, The parameter may correspond to other factors suitable to predict weakening (or completely losing) the wireless communication link, such as a rate of change in the strength of the audio signal, battery power of the wireless peripheral audio device to maintain the wireless communication link, or the like.

In some embodiments, the mobile device may monitor a distance from the wireless peripheral audio device, over the wireless communication link. For example, the mobile device may sample a strength of a signal transmitted from the wireless peripheral audio device to determine the distance. Subsequently, the mobile device may determine that the distance becomes close to (or exceeds) a predetermined threshold (e.g., three (3) meters, eight (8) meters, fifteen (15) meters, even more). The mobile device may notify a user of the mobile device of the situation (e.g., the distance from the wireless peripheral audio device meeting the predetermined threshold, and likely to be lost). In some cases, when the mobile device determines that the distance is equal to or greater than the predetermined threshold, the mobile device may transmit a command to the wireless peripheral audio device—e.g., the command including a request for the wireless peripheral audio device to report its location. When the mobile device receives the location of the wireless peripheral audio device in response to transmitting the command, the mobile device may record the location, and inform the user of the location of the wireless peripheral audio device, along with additional information (e.g., date, time). In some embodiments, the mobile device may transmit another command to the wireless peripheral audio device (e.g., upon receiving the user's request to send such command) to generate a sound such that the user of the mobile device may locate the wireless peripheral audio device by listening for the sound.

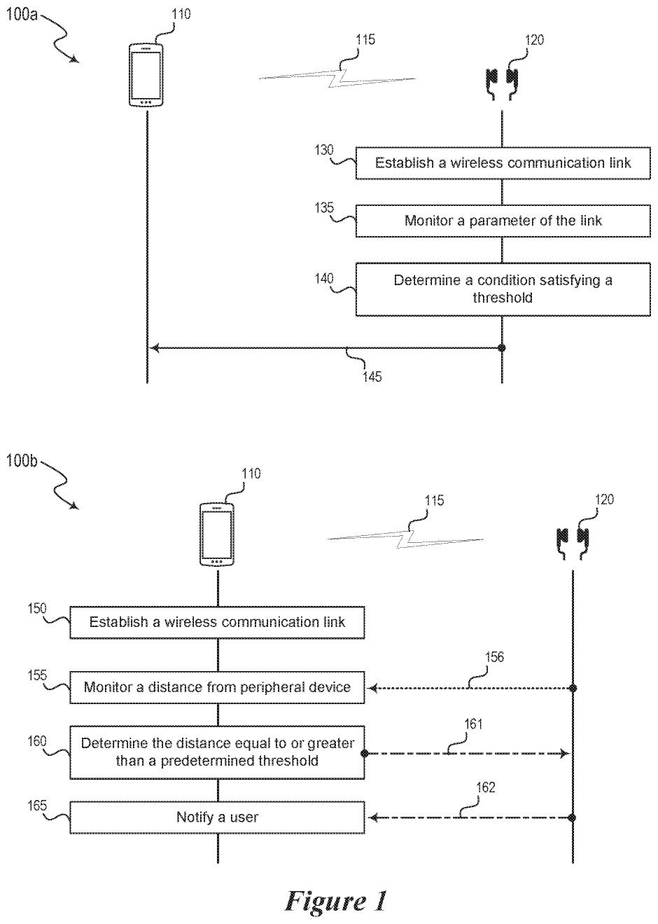

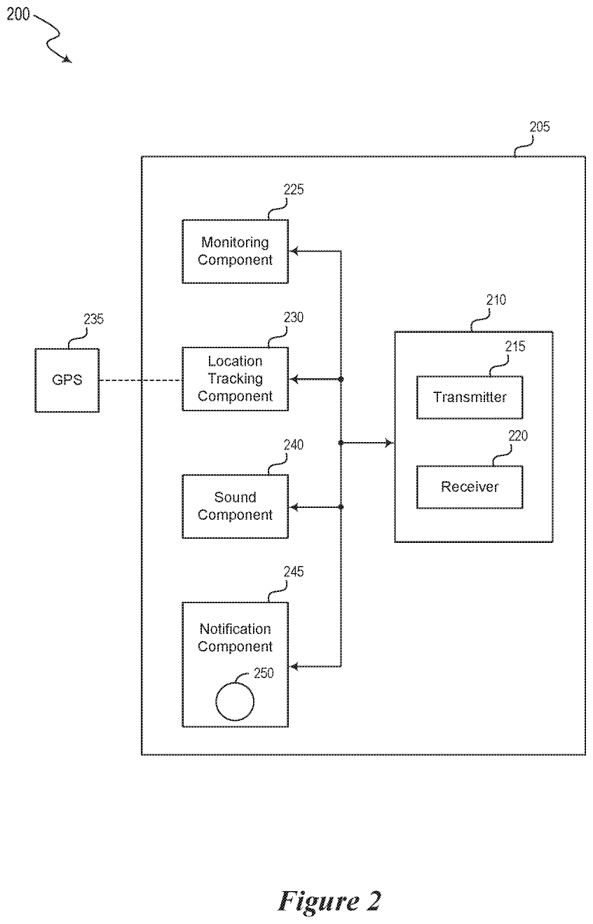

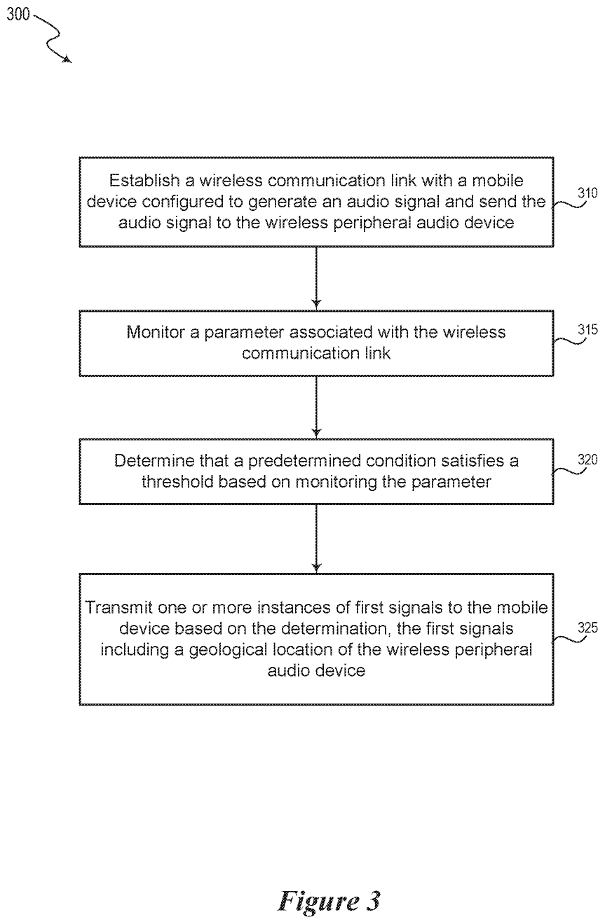

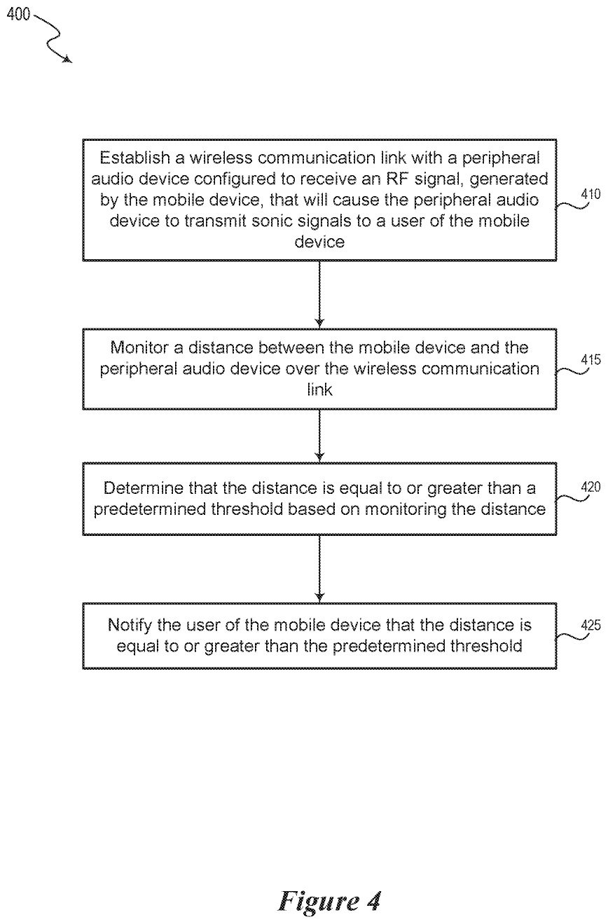

Schemes of tracking a wireless peripheral audio device in accordance with embodiments of the present technology are described with reference to FIG. 1. Detailed descriptions of such wireless peripheral audio device are provided with reference to FIG. 2. Flowcharts illustrating methods of tracking the wireless peripheral audio device are described with reference to FIGS. 3 and 4.

FIG. 1 shows block diagrams 100 illustrating schemes of tracking wireless peripheral audio devices in accordance with embodiments of the present technology. The diagrams 100 depict a mobile device 110 and a wireless peripheral audio device 120. The mobile device 110 and the wireless peripheral audio device 120 may be coupled to each other over a wireless communication link 115. In some embodiments, the wireless communication link 115 includes a wireless link based on various wireless technology standards (e.g., a near-field communication standard, a Bluetooth standard, a wi-fi standard), a cellular network, or the like. In some embodiments, the wireless peripheral audio device 120 may be configured to receive a radio frequency (RF) signal generated by the mobile device 110. Subsequently, the wireless peripheral audio device 120, in response to receiving the RF signal, may transmit sonic signals to a user of the mobile device 110.

The diagram 100a illustrates aspects of operations from perspectives of the wireless peripheral audio device 120 in accordance with embodiments of the present technology. The wireless peripheral audio device 120 may include a pair of earbuds, As such, the tracking and/or locating features described herein may apply when one of the earbuds is misplaced or lost, as well as when both earbuds are lost (e.g., when a holding case including both earbuds is lost). The diagram 100b illustrates aspects of operations from perspectives of the mobile device 110, in conjunction with the wireless peripheral audio device 120 in some cases, in accordance with embodiments of the present technology.

Referring to the diagram 100a, at step 130, the wireless peripheral audio device 120 may establish the wireless communication link 115 with the mobile device 110. The mobile device 110 can be configured to generate an audio signal and send the audio signal to the wireless peripheral audio device 120. At step 135, the wireless peripheral audio device 120 may monitor a parameter associated with the wireless communication link 115. At step 140, the wireless peripheral audio device 120 may, based on monitoring the parameter, determine that a predetermined condition satisfies a threshold (e.g., the condition associated with high likelihoods of losing the wireless communication link 115 or otherwise getting lost). Subsequently, the wireless peripheral audio device 120 may transmit one or more instances of first signals 145 to the mobile device 110. The first signals may include a geological location of the wireless peripheral audio device 120 and/or a request for the mobile device 110 to perform certain tasks. In some cases, the wireless peripheral audio device 120 may determine its geological location based on a location tracking signal from a global positioning system (GPS). As such, the wireless peripheral audio device 120 may spontaneously transmit the first signals upon determining that the predetermined condition satisfies the threshold, e.g., reporting its location to the mobile device 110, in an attempt to provide information regarding its whereabout before losing the wireless communication link 115.

In some cases, the parameter corresponds to a strength of a second signal (e.g., an audio signal) from the mobile device 110 transmitted over the wireless communication link 115. The wireless peripheral audio device 120 may be configured to determine a distance from the mobile device 110 based on monitoring the second signal strength. The wireless peripheral audio device 120 may also include a threshold related to a maximum distance to maintain the wireless communication link 115. Such threshold may vary based on the wireless communication link 115—e.g., several inches for a near-field communication link, several meters for a Bluetooth communication link. When the distance from the mobile device 110 becomes close to or about to exceed the threshold (e.g., satisfying the threshold), the wireless peripheral audio device 120 may transmit the first signals 145 to the mobile device 110.

In some cases, the parameter corresponds to a change in the strength of the second signal from the mobile device 110. The wireless peripheral audio device 120 may be configured to determine a rate of change in a distance from the mobile device based on monitoring the change in the second signal strength. For example, a user wearing the wireless peripheral audio device 120 (e.g., earbuds to listen to music from the mobile device 110) may be jogging on a trail and one of the earbuds falls out. In such situation, the wireless peripheral audio device 120 may respond more efficiently by monitoring the rate of change in the distance. As described above, the wireless peripheral audio device 120 may determine that the distance from the mobile device 110 becomes close to or about to exceed the threshold (e.g., satisfying the threshold) based on determining the rate of change in the distance. Subsequently, the wireless peripheral audio device 120 may spontaneously transmit the first signals 145 to the mobile device 110—e.g., to notify the user or to have the mobile device record the location of the earbuds fell out.

In some cases, the parameter corresponds to battery power of the wireless peripheral audio device 120 that is available for maintaining the wireless communication link 115. The wireless peripheral audio device 120 may be configured to determine a duration to maintain the wireless communication link 115 based on monitoring the batter power. Further, the wireless peripheral audio device 120 may include a threshold related to its battery power to support a time period that the wireless peripheral audio device 120 needs to transmit at least one instance of the first signal to the mobile device 110. When the battery power becomes close to or about to decrease less than the threshold (e.g., satisfying the threshold), the wireless peripheral audio device 120 may transmit the first signals 145 to the mobile device 110.

In some cases, the threshold related to the battery power may be predetermined, e.g., by the user of the wireless peripheral audio device 120, to be a fixed percentage indicating remaining battery power (e.g., 10%, 15%, 20%, or the like) for maintaining the wireless communication link 115. When the battery power becomes close to or about to decrease less than the predetermined fixed percentage (e.g., satisfying the threshold), the wireless peripheral audio device 120 may transmit the first signals 145 to the mobile device 110.

In some cases, the first signals 145 may include various requests for the mobile device 110 to perform based on receiving the first signals 145. For example, the first signals 145 may include a request directed to the mobile device 110 to record a location of the mobile device (which may be determined by a GPS) upon receiving the first signals 145. Additionally or alternatively, the first signals 145 may include a request directed to the mobile device 110 to notify the user of the mobile device 110. Such notification may include various information that may assist the user to track and/or locate the wireless peripheral audio device 120, such as the location of the wireless peripheral audio device 120, time and/or date of the notification, a description of the parameter that the wireless peripheral audio device 120 monitored, among others. In some embodiments, the first signals 145 may include a request directed to the mobile device 110 to relay the geological location of the wireless peripheral audio device 120 to an account of the user of the mobile device 110 (e.g., an account associated with a cellar service provider of the mobile device 110), along with the information that may assist the user to track and/or locate the wireless peripheral audio device 120, in some cases,

Turning to the diagram 100b, at step 150, the mobile device 110 may establish a wireless communication link 115 with a wireless peripheral audio device 120. In some embodiments, the wireless peripheral audio device 120 may be configured to receive an audio signal generated by the mobile device 110. Additionally, or alternatively, the wireless peripheral audio device 120 may be configured to receive an RF signal, generated by the mobile device 110, that will cause the peripheral audio device to transmit sonic signals to a user of the mobile device 110. At step 155, the mobile device 110 may monitor a distance between the mobile device 110 and the wireless peripheral audio device 120 over the wireless communication link 115. In some embodiments, the mobile device 110 may sample a strength of a signal 156 transmitted from the wireless peripheral audio device 120 over the wireless communication link 115 to monitor the distance from the wireless peripheral audio device 120. In some embodiments, the mobile device 110 may receive a location of the wireless peripheral audio device 120 transmitted from the wireless peripheral audio device 120 over the wireless communication link 115 (e.g., as part of the signal 156) to monitor the distance from the wireless peripheral audio device 120.

At step 160, the mobile device 110 may determine that the distance is equal to or greater than a predetermined threshold (e.g., satisfying the threshold) and notify the user of the mobile device 110 at step 165, e.g., notify that the distance is equal to or greater than the predetermined threshold, In some embodiments, the mobile device 110 may record a location of the mobile device prior to notifying the user at step 165. In some embodiments, after determining that the distance satisfies the threshold at step 160, the mobile device 110 may transmit a command to the wireless peripheral audio device 120 (e.g., using a signal 161 to the wireless peripheral audio device 120). In some cases, the command may request the wireless peripheral audio device 120 to report its location.

In some cases, the user may realize that the wireless peripheral audio device 120 is lost or misplaced, and transmit such a command (e.g., the command requesting the wireless peripheral audio device 120 to report its location) using the mobile device 110—e.g., by activating an application supporting the tracking features described herein. As such, the mobile device 110 may be configured to transmit the command to the wireless peripheral audio device 120 independent of the distance between the mobile device 110 and the wireless peripheral audio device 120.

Subsequently, upon receiving the location of the wireless peripheral audio device 120 (e.g., using a signal 162 from the wireless peripheral audio device 120) in response to transmitting the command, the mobile device 110 may notify the user at step 165. Such notification may include various information that may assist the user to track and/or locate the wireless peripheral audio device 120, such as the location of the wireless peripheral audio device 120, time and/or date of the notification, among others. Additionally or alternatively, upon receiving the location of the wireless peripheral audio device 120 (e.g., using the signal 162 from the wireless peripheral audio device 120) in response to transmitting the command, the mobile device 110 may relay the location of the wireless peripheral audio device 120 to an account of the user of the mobile device 110 (e.g., the user's account associated with a cellular service provider of the mobile device), along with the information that may assist the user to track and/or locate the wireless peripheral audio device 120. In some cases, the service provider may send an email informing the user upon receiving the location of the wireless peripheral audio device 120.

FIG. 2 is a block diagram 200 schematically illustrating a wireless peripheral device in accordance with an embodiment of the present technology. The diagram 200 includes a wireless peripheral audio device 205, which may be an example of or include an aspect of the wireless peripheral audio device 120 described with reference to FIG. 1. The wireless peripheral audio device 205 of the diagram 200 includes a wireless communication component 210 comprising a transmitter 215 and a receiver 220, a monitoring component 225, a location tracking component 230, which may be coupled with a global positioning system (GPS) 235, a sound component 240, a notification component 245.

The wireless communication component 210 may be configured to establish a wireless communication link (e.g., the wireless communication link 115) with a mobile device (e.g., the mobile device 110), which may be configured to generate an audio signal and send the audio signal to the wireless peripheral audio device 205. The wireless communication component 210 includes the transmitter 215 configured to transmit signals (e.g., the first signal 145, the signal 156, the signal 162) over the wireless communication link. Further, the wireless communication component 210 includes the receiver 220 configured to receive signals (e.g., the audio signals, the RF signals, the signal 161) over the wireless communication link. The wireless communication component 210 may be coupled with the monitoring component 225, the location tracking component 230, the sound component 240, and the notification component 245, respectively.

The monitoring component 225 may be configured to monitor a parameter associated with the wireless communication link—e.g., one of the parameters described with reference to the diagram 100a of FIG. 1, determine that a predetermined condition (e.g., a distance from the mobile device 110, battery power available to maintain the wireless communication link 115) satisfies a threshold based on monitoring the parameter, and transmit, using the wireless communication component 210, one or more instances of signals (e.g., the first signals 145) to the mobile device based on the determination. The signals may include a location of the wireless peripheral audio device 205, along with additional information described with reference to FIG. 1, in some cases.

The location tracking component 230 may be configured to receive a location tracking signal (e.g., via the wireless communication component 210) from the GPS 235, and determine a geological location of the wireless peripheral audio device 205. The sound component 240 may be configured to generate a sound when activated in response to receiving a command to activate the sound component 240 (e.g., via the wireless communication component 210) over the wireless communication link from the mobile device. In some embodiments, the sound component 240 may, in response to receiving an RF signal from the mobile device, may transmit sonic signals to a user of the mobile device. Further, the notification component 245 may be configured to accept an input from a third party and transmit a notification to the mobile device, an account of a user of the mobile device, or both, using the wireless communication component 210. Such notification may include a location of the wireless peripheral audio device 205. In some cases, the notification component 245 may include a switch 250 configured to accept the input from the third party.

FIG. 3 is a flowchart 300 illustrating a method of tracking wireless peripheral devices in accordance with embodiments of the present technology. The flowchart 300 may be an example of or include aspects of a method that a wireless peripheral audio device (e.g., the wireless peripheral audio device 120, the wireless peripheral audio device 205) may perform as described with reference to FIGS. 1 and 2.

The method includes establishing a wireless communication link with a mobile device configured to generate an audio signal and send the audio signal to the wireless peripheral audio device (box 310). In accordance with one aspect of the present technology, the establishing feature of box 310 can be performed by a wireless communication component (e.g., the wireless communication component 210) as described with reference to FIGS. 1 and 2.

The method further includes monitoring a parameter associated with the wireless communication link (box 315). In accordance with one aspect of the present technology, the monitoring feature of box 315 can be performed by a monitoring component (e.g., the monitoring component 225) as described with reference to FIGS. 1 and 2.

The method further includes determining that a predetermined condition satisfies a threshold based on monitoring the parameter (box 320). In accordance with one aspect of the present technology, the determining feature of box 320 can be performed by a monitoring component (e.g., the monitoring component 225) as described with reference to FIGS. 1 and 2.

The method further includes transmitting one or more instances of first signals to the mobile device based on the determination, the first signals including a geological location of the wireless peripheral audio device (box 325). In accordance with one aspect of the present technology, the establishing feature of box 310 can be performed by a wireless communication component (e.g., the wireless communication component 210) as described with reference to FIGS. 1 and 2.

In some embodiments, the method may further include determining a distance from the mobile device based on monitoring the parameter corresponding to a strength of a second signal from the mobile device transmitted over the wireless communication link, where the predetermined condition is the distance from the mobile device, and the threshold correlates to a maximum distance to maintain the wireless communication link. In some embodiments, the method may further include determining a rate of change in a distance from the mobile device based on monitoring the parameter corresponding to a change in a strength of a second signal from the mobile device transmitted over the wireless communication link, where the predetermined condition is the rate of change in the distance from the mobile device, and the threshold correlates to a maximum distance to maintain the wireless communication link.

In some embodiments, the method further includes determining a duration to maintain the wireless communication link based on monitoring the parameter corresponding to battery power available for maintaining the wireless communication link, where the predetermined condition is the duration to maintain the wireless communication link, and the threshold correlates to a period during which the one or more instances of the first signals are to be transmitted. In some embodiments, the first signals further comprise a request directed to the mobile device to record a location of the mobile device upon receiving the first signals. In some embodiments, the first signals further comprise a request directed to the mobile device to notify a user of the mobile device upon receiving the first signals. In some embodiments, the first signals further comprise a request directed to the mobile device to relay the geological location of the wireless peripheral audio device to an account of a user of the mobile device. In some embodiments, the geological location of the wireless peripheral audio device is determined by a global positioning system (GPS).

FIG. 4 is a flowchart 400 illustrating a method of tracking peripheral devices in accordance with embodiments of the present technology. The flowchart 400 may be an example of or include aspects of a method that a mobile device (e.g., the mobile device 110) may perform as described with reference to FIGS. 1 and 2.

The method includes establishing a wireless communication link with a peripheral audio device configured to receive an RF signal, generated by the mobile device, that will cause the peripheral audio device to transmit sonic signals to a user of the mobile device (box 410). In accordance with one aspect of the present technology, the establishing feature of box 410 can be performed by a mobile device (e.g., the mobile device 110) as described with reference to FIG. 1.

The method further includes monitoring a distance between the mobile device and the peripheral audio device over the wireless communication link (box 415). In accordance with one aspect of the present technology, the monitoring feature of box 415 can be performed by a mobile device (e.g., the mobile device 110) as described with reference to FIG. 1.

The method further includes determining that the distance is equal to or greater than a predetermined threshold based on monitoring the distance (box 420). In accordance with one aspect of the present technology, the determining feature of box 420 can be performed by a mobile device (e.g., the mobile device 110) as described with reference to FIG. 1.

The method further includes notifying the user of the mobile device that the distance is equal to or greater than the predetermined threshold (box 425). In accordance with one aspect of the present technology, the notifying feature of box 425 can be performed by a mobile device (e.g., the mobile device 110) as described with reference to FIG. 1.

In some embodiments, the method may further include sampling a strength of a signal transmitted from the peripheral audio device over the wireless communication link, where monitoring the distance is based on sampling the strength of the signal. In some embodiments, the method may further include receiving a location of the peripheral audio device transmitted from the peripheral audio device over the wireless communication link, where monitoring the distance is based on receiving the location. In some embodiments, the method may further include recording a location of the mobile device based on the determination, where notifying the user of the mobile device is based on recording the location of the mobile device.

In some embodiments, the method further includes transmitting a command to the peripheral audio device based on the determination, the command requesting the peripheral audio device to report a location of the peripheral audio device. In some embodiments, the method further includes receiving the location of the peripheral audio device in response to transmitting the command, where notifying the user is based on receiving the location of the peripheral audio device. In some embodiments, the method further includes receiving the location of the peripheral audio device in response to transmitting the command, and relaying the location of the peripheral audio device to an account of the user of the mobile device, where notifying the user is based on relaying the location of the peripheral audio device.

Several embodiments of the present technology are directed to provide tracking and/or locating features directed to wireless peripheral audio devices. Although the present technology is described with respect to providing the tracking and/or locating features for the wireless peripheral audio devices, the present technology is not limited thereto. For example, other wireless peripheral devices such as portable input devices (e.g., a wireless keyboard, a wireless mouse, a digital stylus, etc.), portable output devices (e.g., Bluetooth speakers, external wireless displays, etc.) or other components (e.g., sensors, imaging devices, microphones, etc.) may similarly benefit from the foregoing approach to tracking and loss prevention. Moreover, the tracking and/or locating features may be implemented in a small apparatus that may be attached to (or embedded in) various non-electronic objects, such as medicine vials, containers including experimental specimens, expensive personal items (e.g., jewelries, wrist watches), pet animals, among others. In some cases, the tracking and/or locating features may be linked with a system (e.g., a local area network of a hospital) such that a group of objects (e.g., a group of mobile patient-supporting equipment) may be monitored simultaneously. In some embodiments, a warning signal (e.g., an alarm) may be transmitted (e.g., by a host of the local area network, by the mobile patient-supporting equipment) when any one object of the group leaves a boundary (e.g., the hospital premise). In some embodiments, individual objects of the group may monitor their locations each other such that the system may receive a notification when any one object of the group (e.g., any one of the patients using the mobile patient-supporting equipment) is likely to be stranded (e.g., lost).

It should be noted that the methods described above describe possible implementations, and that the operations and the steps may be rearranged or otherwise modified and that other implementations are possible. Furthermore, embodiments from two or more of the methods may be combined.

The functions described herein may be implemented in hardware, software executed by a processor, firmware, or any combination thereof. Other examples and implementations are within the scope of the disclosure and appended claims. Features implementing functions may also be physically located at various positions, including being distributed such that portions of functions are implemented at different physical locations.

As used herein, including in the claims, or as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

From the foregoing, it will be appreciated that specific embodiments of the invention have been described herein for purposes of illustration, but that various modifications may be made without deviating from the scope of the invention. Rather, in the foregoing description, numerous specific details are discussed to provide a thorough and enabling description for embodiments of the present technology. One skilled in the relevant art, however, will recognize that the disclosure can be practiced without one or more of the specific details. In other instances, well-known structures or operations often associated with memory systems and devices are not shown, or are not described in detail, to avoid obscuring other aspects of the technology. In general, it should be understood that various other devices, systems, and methods in addition to those specific embodiments disclosed herein may be within the scope of the present technology.

What is claimed is:

1. A method for operating a wireless peripheral audio device, comprising:
establishing a wireless communication link with a mobile device configured to generate an audio signal and send the audio signal to the wireless peripheral audio device;
monitoring a parameter associated with the wireless communication link;
determining that a predetermined condition satisfies a threshold based on monitoring the parameter; and
transmitting one or more instances of first signals to the mobile device based on the determination, the first signals including a geological location of the wireless peripheral audio device.

2. The method of claim 1, further comprising:
determining a distance from the mobile device based on monitoring the parameter corresponding to a strength of a second signal from the mobile device transmitted over the wireless communication link, wherein:
the predetermined condition is the distance from the mobile device; and
the threshold correlates to a maximum distance to maintain the wireless communication link.

3. The method of claim 1, further comprising:
determining a rate of change in a distance from the mobile device based on monitoring the parameter corresponding to a change in a strength of a second signal from the mobile device transmitted over the wireless communication link, wherein:
the predetermined condition is the rate of change in the distance from the mobile device; and
the threshold correlates to a maximum distance to maintain the wireless communication link.

4. The method of claim 1, further comprising:
determining a duration to maintain the wireless communication link based on monitoring the parameter corresponding to battery power available for maintaining the wireless communication link, wherein:
the predetermined condition is the duration to maintain the wireless communication link; and
the threshold correlates to a period during which the one or more instances of the first signals are to be transmitted.

5. The method of claim 1, further comprising:
determining remaining battery power based on monitoring the parameter corresponding to the battery power available for maintaining the wireless communication link, wherein:
the predetermined condition is the remaining battery power; and
the threshold is a fixed percentage in the battery power available for maintaining the wireless communication link.

6. The method of claim 1, wherein the first signals further comprise a request directed to the mobile device to record a location of the mobile device upon receiving the first signals.

7. The method of claim 1, wherein the first signals further comprise a request directed to the mobile device to notify a user of the mobile device upon receiving the first signals.

8. The method of claim 1, wherein the first signals further comprise a request directed to the mobile device to relay the geological location of the wireless peripheral audio device to an account of a user of the mobile device.

9. The method of claim 1, wherein the geological location of the wireless peripheral audio device is determined by a global positioning system (GPS).

10. A method for operating a mobile device, comprising:
establishing a wireless communication link with a peripheral audio device configured to receive an RF signal, generated by the mobile device, that will cause the peripheral audio device to transmit sonic signals to a user of the mobile device;
monitoring a distance between the mobile device and the peripheral audio device over the wireless communication link;
determining that the distance is equal to or greater than a predetermined threshold based on monitoring the distance; and
notifying the user of the mobile device that the distance is equal to or greater than the predetermined threshold.

11. The method of claim 10, further comprising:
sampling a strength of a signal transmitted from the peripheral audio device over the wireless communication link, wherein monitoring the distance is based on sampling the strength of the signal.

12. The method of claim 10, further comprising:
receiving a location of the peripheral audio device transmitted from the peripheral audio device over the wireless communication link, wherein monitoring the distance is based on receiving the location.

13. The method of claim 10, further comprising:
recording a location of the mobile device based on the determination, wherein notifying the user of the mobile device is based on recording the location of the mobile device.

14. The method of claim 10, further comprising:
transmitting a command to the peripheral audio device based on the determination, the command requesting the peripheral audio device to report a location of the peripheral audio device.

15. The method of claim 14, further comprising:
receiving the location of the peripheral audio device in response to transmitting the command, wherein notifying the user is based on receiving the location of the peripheral audio device.

16. The method of claim 14, further comprising:
receiving the location of the peripheral audio device in response to transmitting the command; and
relaying the location of the peripheral audio device to an account of the user of the mobile device, wherein notifying the user is based on relaying the location of the peripheral audio device.

17. A wireless peripheral audio device, comprising:
a wireless communication component configured to establish a wireless communication link with a mobile device configured to generate an audio signal and send the audio signal to the wireless peripheral audio device; and
a monitoring component configured to:
monitor a parameter associated with the wireless communication link;
determine that a predetermined condition satisfies a threshold based on monitoring the parameter; and
transmit, using the wireless communication component, one or more instances of signals to the mobile device based on the determination, the signals including a location of the wireless peripheral audio device.

18. The wireless peripheral audio device of claim 17, further comprising:
a location tracking component configured to receive a location tracking signal from a global positioning system (GPS).

19. The wireless peripheral audio device of claim 17, further comprising:
a sound component configured to generate a sound when activated in response to receiving a command over the wireless communication link from the mobile device, the command directed to activating the sound component.

20. The wireless peripheral audio device of claim 17, further comprising:
a notification component configured to accept an input from a third party and transmit a notification to the mobile device, an account of a user of the mobile device, or both, using the wireless communication component.
